(19) United States
(12) Patent Application Publication
(10) Pub. No.: US 2016/0170513 A1
(43) Pub. Date: Jun. 16, 2016

(54) TOUCH PANEL AND DISPLAY DEVICE INCLUDING THE SAME

(71) Applicant: Samsung Display Co. Ltd., Yongin-City (KR)

(72) Inventors: Hyun Ju LEE, Seoul (KR); Moon Sung CHOI, Incheon (KR); In Cheol KIM, Goyang-si, Gyeonggi-do (KR); Byoung Won CHOI, Asan-si, Chungcheongnam-do (KR); Jin Woo PARK, Cheonan-si, Chungcheongnam-do (KR)

(21) Appl. No.: 14/671,889

(22) Filed: Mar. 27, 2015

(30) Foreign Application Priority Data
Dec. 10, 2014 (KR) 10-2014-0177678

(51) Int. Cl. G06F 3/041

(52) U.S. Cl. CPC G06F 3/041; G06F 2203/04104

(57) ABSTRACT

A touch panel includes: a substrate including a first sensing area, a second sensing area, and a non-sensing area located therebetween; a plurality of first and second sensing electrodes located on the first sensing area and the second sensing area, respectively; a first boundary sensing electrode located at a boundary between the first sensing area and the non-sensing area; a plurality of first wiring lines partially located on the first sensing area and connected to the first sensing electrodes; a plurality of second wiring lines partially located on the second sensing area and connected to the second sensing electrodes; a first touch controller electrically connected to the first sensing electrodes by the first wiring lines; a second touch controller electrically connected to the second sensing electrodes by the second wiring lines; and a third wiring line electrically connected to the first boundary sensing electrode and the second touch controller.

This application claims priority from Korean Patent Application No. 10-2014-0177678 filed Dec. 10, 2014 in the Korean Intellectual Property Office, the disclosure of which is incorporated herein by reference in its entirety.

### BACKGROUND

1. Technical Field

The present disclosure generally relates to a touch panel and a display device including the same.

2. Description of the Related Art

Touch panels are currently being incorporated into liquid crystal displays (LCDs) or organic light-emitting displays as input devices. A touch panel is a device that is used to input a command. For example, a user may input a command by touching the touch panel with a finger or an object such as a pen. Touch panels are generally classified into resistive, photosensing, and capacitive touch panels.

Of the above types of touch panels, a capacitive touch panel detects a touch signal by sensing a change in capacitance between a conductive sensing pattern and an adjacent sensing pattern (or a ground electrode) when a user touches the touch panel with a finger or an object.

The touch signal may be detected by a touch controller. When the touch panel has a relatively small area, a touch signal for the entire area of the touch panel can be detected using one touch controller. However, when the touch panel has a relatively large area, it may be difficult to detect a touch signal for the entire area of the touch panel using only one touch controller. In the latter case, the touch signal may be detected using two or more touch controllers.

However, if multiple touch controllers are used, touch detection sensitivity may be reduced at a boundary of an area covered by each of the touch controllers.

### SUMMARY

The present disclosure addresses at least the above issues in the prior art.

According to an embodiment of the inventive concept, a touch panel is provided. The touch panel includes: a substrate comprising a first sensing area, a second sensing area, and a non-sensing area located between the first sensing area and the second sensing area; a plurality of first sensing electrodes located on the first sensing area of the substrate; a plurality of second sensing electrodes located on the second sensing area of the substrate; a first boundary sensing electrode located at a boundary between the first sensing area and the non-sensing area of the substrate; a plurality of first wiring lines partially located on the first sensing area of the substrate and connected to the first sensing electrodes; a plurality of second wiring lines partially located on the second sensing area of the substrate and connected to the second sensing electrodes; a first touch controller electrically connected to the first sensing electrodes by the first wiring lines; a second touch controller electrically connected to the second sensing electrodes by the second wiring lines; and a third wiring line electrically connected to the first boundary sensing electrode and the second touch controller.

In some embodiments, at least part of the third wiring line may be located on the non-sensing area of the substrate.

In some embodiments, the substrate may further include an edge area located around the first sensing area and the second sensing area, and wherein at least part of the third wiring line may be located on the edge area of the substrate.

In some embodiments, the first boundary sensing electrode may be electrically connected to the first touch controller by any one of the first wiring lines.

In some embodiments, the first boundary sensing electrode may not be connected to any of the first wiring lines.

In some embodiments, the touch panel may further include: a second boundary sensing electrode located at a boundary between the second sensing area and the non-sensing area of the substrate; and a fourth wiring line electrically connected to the second boundary sensing electrode and the first touch controller.

In some embodiments, at least part of the fourth wiring line may be located on the first sensing area of the substrate.

In some embodiments, the substrate may further include an edge area located around the first sensing area and the second sensing area, and wherein at least part of the fourth wiring line may be located on the edge area of the substrate.

In some embodiments, the second boundary sensing electrode may be electrically connected to the second touch controller by any one of the second wiring lines.

In some embodiments, the second boundary sensing electrode may not be connected to any of the second wiring lines.

In some embodiments, the first sensing electrodes and the second sensing electrodes may be located on a same layer.

In some embodiments, the first sensing electrodes and the second sensing electrodes may be made of a same material.

In some embodiments, the first wiring lines, the second wiring lines, and the third wiring line may be located on the same layer as the first sensing electrodes and the second sensing electrodes.

According to another embodiment of the inventive concept, a display device is provided. The display device includes: a touch panel; and a display panel disposed on a side of the touch panel, wherein the touch panel includes: a substrate comprising a first sensing area, a second sensing area, and a non-sensing area located between the first sensing area and the second sensing area; a plurality of first sensing electrodes located on the first sensing area of the substrate; a plurality of second sensing electrodes located on the second sensing area of the substrate; a first boundary sensing electrode located at a boundary between the first sensing area and the non-sensing area of the substrate; a plurality of first wiring lines partially located on the first sensing area of the substrate and connected to the first sensing electrodes; a plurality of second wiring lines partially located on the second sensing area of the substrate and connected to the second sensing electrodes; a first touch controller electrically connected to the first sensing electrodes by the first wiring lines; a second touch controller electrically connected to the second sensing electrodes by the second wiring lines; and a third wiring line electrically connected to the first boundary sensing electrode and the second touch controller.

In some embodiments, the display panel may include an organic light-emitting device or a liquid crystal device.

### BRIEF DESCRIPTION OF THE DRAWINGS

The above and other aspects and features of the inventive concept will be more apparent in view of the following description of exemplary embodiments with reference to the accompanying drawings.

FIG. 1 is a schematic side view of a display device according to an embodiment.

FIG. 2 is an enlarged view of a portion of FIG. 1.

FIG. 3 is a schematic plan view of a touch panel according to an embodiment.

FIG. 4 is a schematic plan view of a touch panel according to another embodiment.

FIG. 5 is a schematic plan view of a touch panel according to another embodiment.

FIG. 6 is a schematic plan view of a touch panel according to another embodiment.

FIG. 7 is a schematic plan view of a touch panel according to another embodiment.

FIG. 8 is a schematic plan view of a touch panel according to another embodiment.

### DETAILED DESCRIPTION

Advantages and features of the inventive concept and methods of accomplishing the same may be understood more readily with reference to the following detailed description of certain embodiments and the accompanying drawings. The inventive concept may, however, be embodied in many different forms and should not be construed as being limited to the embodiments set forth herein. Rather, these embodiments are provided so that this disclosure is thorough and complete and fully conveys the inventive concept to those skilled in the art. Like reference numerals refer to like elements throughout the specification.

The terminology used herein is for describing the embodiments and is not intended to limit the inventive concept. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being “on”, “connected to” or “coupled to” another element or layer, it can be directly on, connected or coupled to the other element, or with one or more intervening elements or layers being present. In contrast, when an element is referred to as being “directly on”, “directly connected to” or “directly coupled to” another element or layer, there are no intervening elements or layers present. As used herein, the term “and/or” includes any and all combinations of one or more of the associated listed items.

It will be understood that, although the terms “first”, “second”, etc. may be used herein to describe various elements, components, regions, layers and/or sections, the elements, components, regions, layers and/or sections should not be limited by those terms. Those terms are merely used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “above”, “upper”, and the like, may be used herein to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

Embodiments are described herein with reference to cross-section illustrations that are schematic illustrations of idealized embodiments (and intermediate structures). As such, variations from the shapes of the illustrations as a result of, for example, manufacturing techniques and/or tolerances, are to be expected. Thus, these embodiments should not be construed as being limited to the shapes of regions illustrated herein but are to include deviations in shapes that result, for example, due to manufacturing. Thus, the regions illustrated in the figures are schematic in nature and their shapes are not intended to illustrate the actual shape of a region of a device and are not intended to limit the scope of the inventive concept.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

Embodiments of the inventive concept will be described herein with reference to the attached drawings.

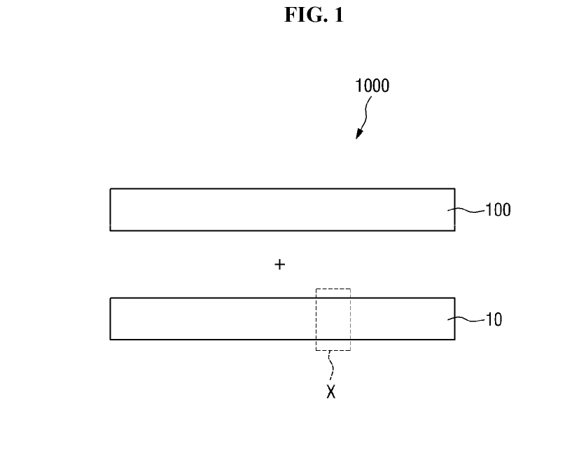

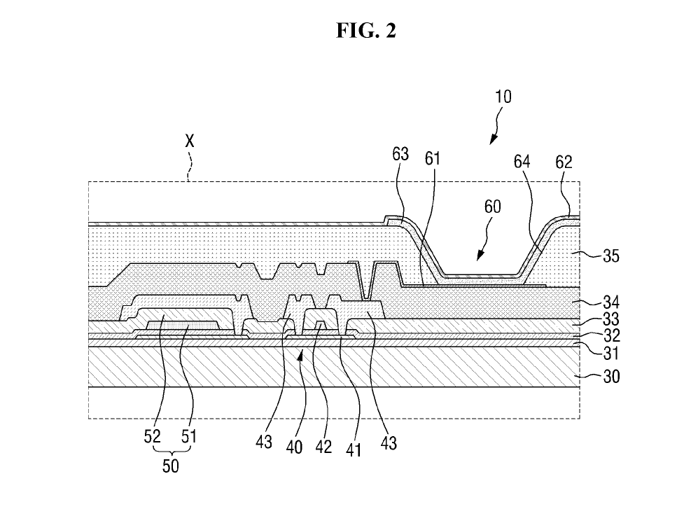

FIG. 1 is a schematic side view of a display device 1000 according to an embodiment. FIG. 2 is an enlarged view of a portion of FIG. 1, specifically portion ‘X’ of FIG. 1.

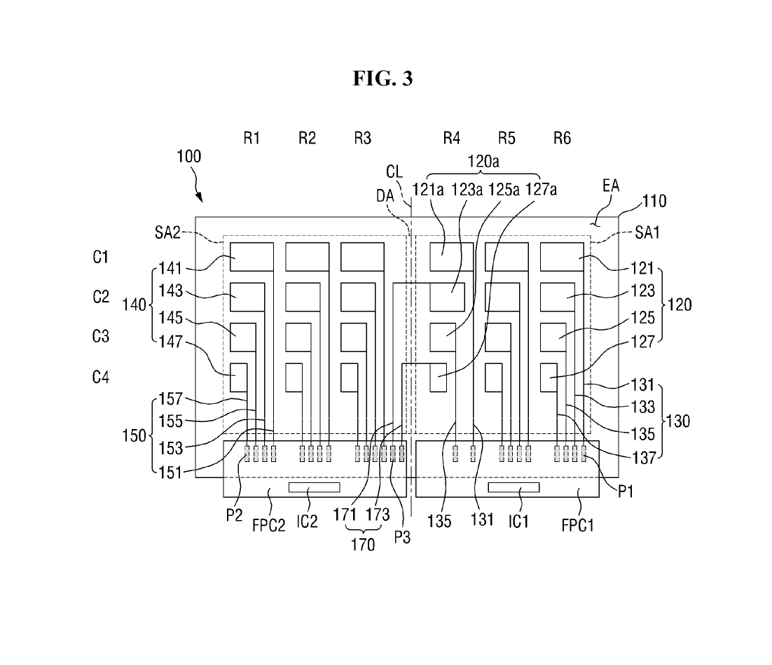

Referring to FIGS. 1 and 2, the display device 1000 may include a touch panel 100 and a display panel 10. The touch panel 100 will be described in further detail with reference to FIGS. 3 through 8.

The touch panel 100 and the display panel 10 may be coupled to each other directly without using a separate coupling member. In some alternative embodiments, a coupling member for coupling the touch panel 100 and the display panel 10 may be inserted between the touch panel 100 and the display panel 10.

In the embodiment of FIG. 1, the touch panel 100 is disposed above the display panel 10. However, the inventive concept is not limited thereto. In some embodiments, the touch panel 100 may be disposed under the display panel 10. In some further embodiments (not illustrated), a first touch panel 100 and a second touch panel 100 may be respectively disposed above and under the display panel 10.

The display panel 10 may include different light emitting mechanisms. For example, the display panel 10 may include an organic light-emitting device or a liquid crystal device.

An embodiment in which the display panel 10 includes an organic light-emitting device will be described with reference to FIG. 2. Referring to FIG. 2, the display panel 10 may include a substrate 30, a buffer layer 31, a thin-film transistor (TFT) 40, a capacitor 50, and an organic light-emitting device 60.

The substrate 30 may be made of a glass material, a plastic material, or a metal material. In some embodiments, the substrate 30 may be made of a flexible plastic material. Accordingly, when the touch panel 100 is flexible, the display device 1000 may be implemented as a flexible display device.

The buffer layer 31 may be formed on the substrate 30. The buffer layer 31 may provide a planar surface on the substrate 30. The buffer layer 31 may be made of an insulating material that protects the substrate 30 from moisture and foreign matter.

The TFT 40, the capacitor 50, and the organic light-emitting device 60 may be formed on the buffer layer 31. The TFT 40 may include an active layer 41, a gate electrode 42, and source/drain electrodes 43. The organic light-emitting device 60 may include a first electrode 61, a second electrode 62, and a middle layer 63. In some embodiments, the capacitor 50 includes a first capacitor electrode 51 and a second capacitor electrode 52.

Specifically, the active layer 41 may be formed having a predetermined pattern and disposed on an upper surface of the buffer layer 31. The active layer 41 may contain an inorganic semiconductor material such as silicon, an organic semiconductor material, or an oxide semiconductor material, and may be formed by injecting p-type or n-type dopants into the aforementioned materials.

A gate insulating layer 32 may be formed on the active layer 41, and the gate electrode 42 may be formed on the gate insulating layer 32 and disposed corresponding to the active layer 41. An interlayer insulating film 33 may be formed covering the gate electrode 42, the source/drain electrodes 43 may be formed on the interlayer insulating film 33, and each of the source/drain electrodes 43 may contact a region of the active layer 41. In addition, a passivation layer 34 may be formed covering the source/drain electrodes 43. In some embodiments, an additional insulating layer (not illustrated) may be formed on the passivation layer 34 to provide a planar surface for the TFT 40.

The first electrode 61 may be formed on the passivation layer 34. The first electrode 61 may be electrically connected to any one of the source/drain electrodes 43. A pixel defining layer 35 may be formed covering the first electrode 61. After an opening 64 is formed in the pixel defining layer 35, the middle layer 63 may be formed in a region defined by the opening 64, and the second electrode 62 may be formed on the middle layer 63. The middle layer 63 may include an organic light-emitting layer.

An encapsulation layer (not illustrated) may be formed on the second electrode 62. The encapsulation layer may be made of various materials. For example, the encapsulation layer may contain an organic material or an inorganic material. In some embodiments, the encapsulation layer may be a structure comprising an organic material and an inorganic material stacked alternately. In some further embodiments, the encapsulation layer may be made of a glass material. In some alternative embodiments, a substrate of the touch panel 100 may be used as the encapsulation layer.

FIG. 3 is a schematic plan view of a touch panel 100 according to an embodiment. More specifically, FIG. 3 is a plan view of the touch panel 100 of FIG. 1 according to an embodiment.

Referring to FIG. 3, the touch panel 100 may include a substrate 110, first sensing electrodes 120, first wiring lines 130, second sensing electrodes 140, second wiring lines 150, a first touch controller IC1, a second touch controller IC2, and third wiring lines 170.

The substrate 110 may include a first sensing area SA1, a second sensing area SA2, and a non-sensing area DA. The substrate 110 may further include an edge area EA located around the first sensing area SA1, the second sensing area SA2, and the non-sensing area DA.

The first sensing area SA1 may be an area in which the first sensing electrodes 120 are located, and the second sensing area SA2 may be an area in which the second sensing electrodes 140 are located. The non-sensing area DA may be located between the first sensing area SA1 and the second sensing area SA2, and no sensing electrodes may be located in the non-sensing area DA. In some embodiments, the non-sensing area DA may be defined as an area including a boundary line CL that separates the first sensing area SA1 and the second sensing area SA2.

The substrate 110 may be made of a transparent material. In some embodiments, the transparent material may be tempered glass, acrylic resin, polyethylene terephthalate (PET), polycarbonate (PC), polyimide (PI), polyethersulfone (PES), polyimide (PI), polymethyl methacrylate (PMMA), polyethylene naphthalate (PEN), metal foil, fiber reinforced plastic (FRP), or silicon rubber. In some embodiments, the substrate 110 may be a high-strength substrate. In some other embodiments, the substrate 110 may be a flexible substrate.

The first sensing electrodes 120 may be located on the first sensing area SA1 of the substrate 110, and the second sensing electrodes 140 may be located on the second sensing area SA2 of the substrate 110. The first sensing electrodes 120 and the second sensing electrodes 140 are electrodes that are patterned on the substrate 110. The first sensing electrodes 120 and the second sensing electrodes 140 are configured to detect a touch input based on a change in capacitance between the electrodes 120/140 and a user's finger or a conductor.

Each of the first and second sensing electrodes 120 and 140 may have a polygonal shape. In the example of FIG. 3, each of the first and second sensing electrodes 120 and 140 has a quadrilateral shape. However, it should be noted that the first and second sensing electrodes 120 and 140 are not limited to a quadrilateral shape, and may be formed in various shapes.

The first sensing electrodes 120 and the second sensing electrodes 140 may be located at a same level. If the first sensing electrodes 120 and the second sensing electrodes 140 are located at the same level, it means that the first sensing electrodes 120 and the second sensing electrodes 140 are located on a same layer. In some embodiments, the first sensing electrodes 120 and the second sensing electrodes 140 may be formed directly on a surface of the substrate 110.

The first sensing electrodes 120 and the second sensing electrodes 140 may be made of an optically transparent conductive material. In some embodiments, the optically transparent conductive material may be a conductive material that is transparent. In other embodiments, the first sensing electrodes 120 and the second sensing electrodes 140 may be made of a conductive material that is opaque but perceived to be transparent when viewed with the naked eye, because the constituent units of the conductive material may be very small and arranged at a density beyond what a typical human eye can resolve. Examples of the optically transparent conductive material may include transparent conductive oxide such as indium tin oxide (ITO), indium zinc oxide (IZO) or zinc oxide (ZO), a carbon nanomaterial, nanowires, a conductor such as a conductive polymer, metal particles or metal in the form of a thin film or a mesh, or combinations of one or more of the above.

The carbon nanomaterial may be single-wall carbon nanotubes, multi-wall carbon nanotubes, carbon nanoparticles, or graphene.

The nanowires may be silver nanowires, copper nanowires, gold nanowires, platinum nanowires, or silicon nanowires.

Examples of the conductive polymer may include polyethylene dioxythiophene (PEDOT), poly(3,4-ethylenedioxythiophene)polystyrene sulfonate (PEDOT:PSS), poly(3-alkyl)thiophene (P3AT), poly(3-hexyl)thiophene (P3HT), polyaniline (PANT), polyacetylene (PA), polyazulene, polyisothianapthalene (PITN), polyisothianaphthene, polythienylenevinylene, polythiophene (PT), polyparaphenylene (PPP), polyparaphenylene vinylene (PPV), polyphenylene sulfide, polyphenylene, polyfuran, polypyrrole (PPY), or polyheptadiyne (PHT).

Examples of the metal particles or metal in the mesh form may include silver (Ag), aluminum (Al), copper (Cu), chrome (Cr), or nickel (Ni).

In some embodiments, the first sensing electrodes 120 and the second sensing electrodes 140 may be formed of a same material in a same process.

In some embodiments, the first sensing electrodes 120 may have different sizes. For example, in one embodiment, among the first sensing electrodes 120, sensing electrodes that are located in a first row C1, a second row C2, a third row C3, and a fourth row C4 may be defined as first row-first sensing electrodes 121, second row-first sensing electrodes 123, third row-first sensing electrodes 125, and fourth row-first sensing electrodes 127, respectively. In the above embodiment, the first row-first sensing electrodes 121 may be larger in size than the second row-first sensing electrodes 123. Likewise, the third row-first sensing electrodes 125 may be smaller in size than the second row-first sensing electrodes 123 and larger in size than the fourth row-first sensing electrodes 127. However, the above configuration is merely exemplary. In some other embodiments, the first sensing electrodes 120 may have the same size.

Similar to the first sensing electrodes 120, the second sensing electrodes 140 may also have different sizes. For example, in one embodiment, among the second sensing electrodes 140, sensing electrodes that are located in the first row C1, the second row C2, the third row C3, and the fourth row C4 may be defined as first row-second sensing electrodes 141, second row-second sensing electrodes 143, third row-second sensing electrodes 145, and fourth row-second sensing electrodes 147, respectively. In the above embodiment, the first row-second sensing electrodes 141 may be larger in size than the second row-second sensing electrodes 143. Likewise, the third row-second sensing electrodes 145 may be smaller in size than the second row-second sensing electrodes 143 and larger in size than the fourth row-second sensing electrodes 147. However, the above configuration is merely exemplary. In some other embodiments, the second sensing electrodes 140 may have the same size.

First boundary sensing electrodes 120a may be located in a portion of the first sensing area SA1 that is adjacent to the non-sensing area DA. The first boundary sensing electrodes 120a may be formed of substantially the same shape and material as the first sensing electrodes 120. However, the first boundary sensing electrodes 120a may be different from the first sensing electrodes 120 in that they are disposed adjacent to the non-sensing area DA. For example, in one embodiment, among the electrodes located in the first sensing area SA1, electrodes that are located in a fifth column R5 and a sixth column R6 may be defined as the first sensing electrodes 120, and electrodes that are located in a fourth column R4 closest to the non-sensing area DA may be defined as the first boundary sensing electrodes 120a. Other features of the first boundary sensing electrodes 120a are similar to those of the first sensing electrodes 120, and thus a detailed description of those similar features will be omitted.

In the interest of clarity and for ease of description, among the first boundary sensing electrodes 120a, sensing electrodes that are located in the first row C1, the second row C2, the third row C3 and the fourth row C4 are defined as a first row-first boundary sensing electrode 121a, a second row-first boundary sensing electrode 123a, a third row-first boundary sensing electrode 125a, and a fourth row-first boundary sensing electrode 127a, respectively.

First pads P1 may be located in a portion of the edge area EA that is adjacent to the first sensing area SA1, and second pads P2 may be located in a portion of the edge area EA that is adjacent to the second sensing area SA2. Furthermore, one or more third pads P3 may be located in the portion of the edge area EA that is adjacent to the second sensing area SA2.

The first touch controller IC1 may be connected to the first pads P1 by a first flexible printed circuit board FPC1, and the second touch controller IC2 may be connected to the second pads P2 and the third pads P3 by a second flexible printed circuit board FPC2. In the example of FIG. 3, two sensing areas are provided. However, the inventive concept is not limited thereto. In some embodiments, three or more sensing areas may be provided. In particular, the number of touch controllers may be increased according to the number of sensing areas.

The first wiring lines 130 may electrically connect the first sensing electrodes 120 to the respective first pads P1. Accordingly, the first sensing electrodes 120 may be electrically connected to the first touch controller IC1 by the first wiring lines 130. When a touch event occurs in the first sensing area SA1, the first touch controller IC1 may detect a capacitive change in the first sensing electrodes 120 as a touch signal and determine whether the touch event has occurred based on the detected touch signal. Likewise, the second wiring lines 150 may electrically connect the second sensing electrodes 140 to the respective second pads P2. Accordingly, the second sensing electrodes 140 may be electrically connected to the second touch controller IC2 by the second wiring lines 150. When a touch event occurs in the second sensing area SA2, the second touch controller IC2 may detect a capacitive change in the second sensing electrodes 140 as a touch signal and determine whether the touch event has occurred based on the detected touch signal.

At least part of the first wiring lines 130 may be located in the first sensing area SA1, and at least part of the second wiring lines 150 may be located in the second sensing area SA2. In some embodiments, the first wiring lines 130 may be located in the first sensing area SA1 and the edge area EA, and the second wiring lines 150 may be located in the second sensing area SA2 and the edge area EA.

In the interest of clarity and for ease of description, among the first wiring lines 130, a wiring line that is connected to each of the first row-first sensing electrodes 121 or the first row-first boundary sensing electrode 121a is defined as a first row-first wiring line 131, a wiring line that is connected to each of the second row-first sensing electrodes 123 or the second row-first boundary sensing electrode 123a is defined as a second row-first wiring line 133, a wiring line that is connected to each of the third row-first sensing electrodes 125 or the third row-first boundary sensing electrode 125a is defined as a third row-first wiring line 135, and a wiring line that is connected to each of the fourth row-first sensing electrodes 127 or the fourth row-first boundary sensing electrode 127a is defined as a fourth row-first wiring line 137. Likewise, among the second wiring lines 150, a wiring line that is connected to each of the first row-second sensing electrodes 141 is defined as a first row-second wiring line 151, a wiring line that is connected to each of the second row-second sensing electrodes 143 is defined as a second row-second wiring line 153, a wiring line that is connected to each of the third row-second sensing electrodes 145 is defined as a third row-second wiring line 155, and a wiring line that is connected to each of the fourth row-second sensing electrodes 147 is defined as a fourth row-second wiring line 157.

At least any one of the first boundary sensing electrodes 120a may be connected to the third pad P3 by the third wiring line 170. For example, in one embodiment, among the first boundary sensing electrodes 120a, the second row-first boundary sensing electrode 123a may be connected to the third pad P3 by any one (herein referred to as a ‘second row-third wiring line’ 171) of the third wiring lines 170, and the fourth row-first boundary sensing electrode 127a may be connected to the third pad P3 by the other one (herein referred to as a ‘fourth row-third wiring line’ 173) of the third wiring lines 170. In some embodiments, the second row-first boundary sensing electrode 123a and the fourth row-first boundary sensing electrode 127a that are connected to the third wiring lines 170 may not be connected to the first wiring lines 130. In some embodiments, the first row-first boundary sensing electrode 121a and the third row-first boundary sensing electrode 125a may not be connected to the third wiring lines 170, and instead may be connected to first pads P1 by a first row-first wiring line 131 and a third row-first wiring line 135. Accordingly, a capacitive change in the second row-first boundary sensing electrode 123a and the fourth row-first boundary sensing electrode 127a among the first boundary sensing electrodes 120a may be detected as a touch signal by the second touch controller IC2, and a capacitive change in the first row-first boundary sensing electrode 121a and the third row-first boundary sensing electrode 125a may be detected as a touch signal by the first touch controller IC1. A final determination on whether a touch event has occurred may be made based on the touch signal detected by each of the first touch controller IC1 and the second touch controller IC2. That is, when a touch event occurs near the non-sensing area DA, whether the touch event has occurred may be determined based on touch signals detected by the two touch controllers IC1 and IC2. Accordingly, touch sensitivity can be improved using the above embodiments.

In another embodiment (not illustrated), the second row-first boundary sensing electrode 123a and the fourth row-first boundary sensing electrode 127a that are connected to the third wiring lines 170 may be connected by the first wiring lines 130. Specifically, the second row-first boundary sensing electrode 123a may be electrically connected to the first pad P1 by the second row-first wiring line 133, and the fourth row-first boundary sensing electrode 127a may be connected to the first pad P1 by the fourth row-first wiring line 137. In addition, the first row-first boundary sensing electrode 121a and the fourth row-first boundary sensing electrode 127a may not be connected to the third wiring lines 170, and instead may be connected to the first pads P1 by the first row-first wiring line 131 and the third row-first wiring line 135. Accordingly, a capacitive change in the second row-first boundary sensing electrode 123a and the fourth row-first boundary sensing electrode 127a among the first boundary sensing electrodes 120a may be detected as a touch signal by both the first touch controller IC1 and the second touch controller IC2, and a capacitive change in the first row-first boundary sensing electrode 121a and the third row-first boundary sensing electrode 125a may be detected as a touch signal by the first touch controller IC1. A final determination on whether a touch event has occurred may be made based on the touch signal detected by each of the first touch controller IC1 and the second touch controller IC2.

In some embodiments, at least part of the third wiring lines 170 may be located in the non-sensing area DA. For example, in one embodiment, the third wiring lines 170 may be located in all of the first sensing area SA1, the non-sensing area DA, and the second sensing area SA2, whereas portions of the third wiring lines 170 that are connected to the third pads P3 may be located in the edge area EA.

The first wiring lines 130, the second wiring lines 150, and the third wiring lines 170 may be located at a same level. In some embodiments, the first wiring lines 130, the second wiring lines 150, and the third wiring lines 170 may all be formed directly on the surface of the substrate 110. In some embodiments, the first wiring lines 130, the second wiring lines 150, and the third wiring lines 170 may be located at the same level as the first sensing electrodes 120 and the second sensing electrodes 140.

The first wiring lines 130, the second wiring lines 150 and the third wiring lines 170 may be made of a conductive material. The conductive material may be a metal material with low resistivity. Accordingly, the conductive material may reduce the resistance between the sensing electrodes 120 and 140 or the resistance between the sensing electrodes 120 and 140 and the wiring lines 130, 150 and 170, thereby improving detection sensitivity. In some embodiments, the conductive material may include, but is not limited to, any one of molybdenum (Mo), silver (Ag), titanium (Ti), aluminum (Al), copper (Co), gold (Au), platinum (Pt), or nickel (Ni), or an alloy of one or more of the above elements. The first wiring lines 130, the second wiring lines 150, and the third wiring lines 170 may also be made of the same conductive materials as the first sensing electrodes 120 and the second sensing electrodes 140.

In some embodiments, the first wiring lines 130, the second wiring lines 150 and the third wiring lines 170 may be made of a same material in a same process. In some embodiments, the first wiring lines 130, the second wiring lines 150 and the third wiring lines 170 may be made of the same material as the first sensing electrodes 120 and the second sensing electrodes 140.

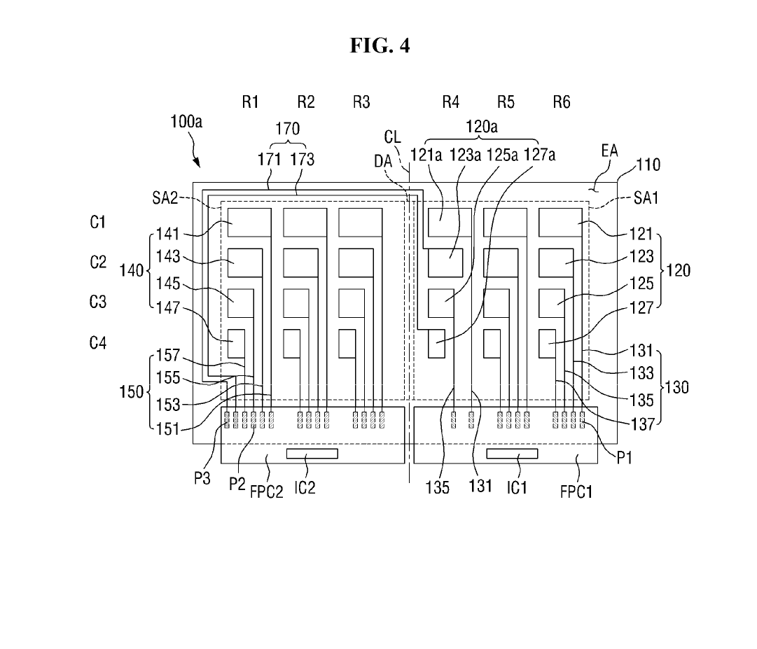

FIG. 4 is a schematic plan view of a touch panel 100a according to another embodiment. The touch panel 100a of FIG. 4 is substantially similar to the touch panel 100 of FIG. 3 except for the positions of the third wiring lines 170. A repeated description of those similar elements will be omitted. Instead, the following description shall focus on the differences between the touch panel 100a of FIG. 4 and the touch panel 100 of FIG. 3.

Referring to FIG. 4, the third wiring lines 170 may be substantially located in an edge area EA in the touch panel 100a. More specifically, the third wiring lines 170 may not be located in a non-sensing area DA, and instead may be located in a first sensing area SA1 and a portion of the edge area EA outside a second sensing area SA2. In some embodiments, at least part of the third wiring lines 170 may be located in the second sensing area SA2.

In the example of FIG. 4, both the second row-third wiring line 171 and the fourth row-third wiring line 173 among the third wiring lines 170 are not located in the non-sensing area DA. However, the above configuration is merely exemplary. In some embodiments, any one of the second row-third wiring line 171 and the fourth row-third wiring line 173 may be located in the non-sensing area DA, as illustrated in FIG. 3.

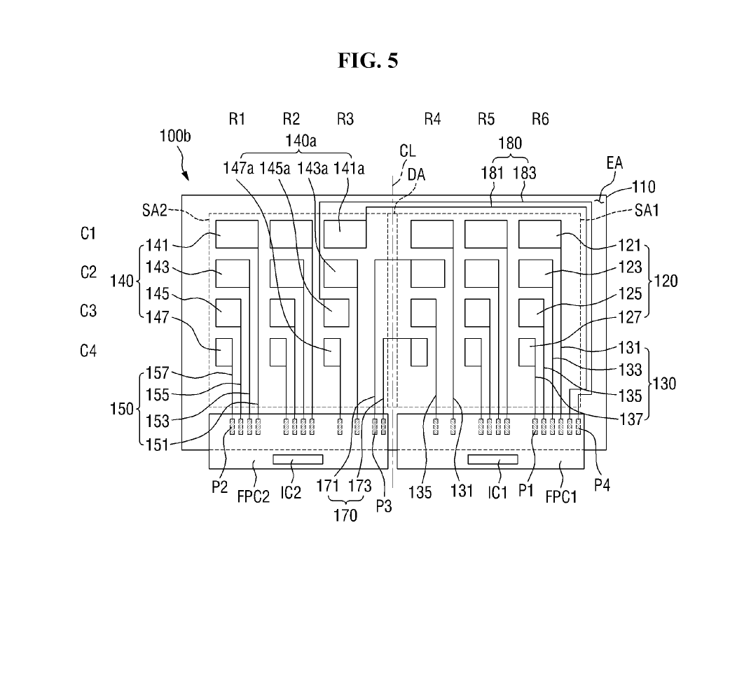

FIG. 5 is a schematic plan view of a touch panel 100b according to another embodiment. The touch panel 100b of FIG. 5 is substantially similar to the touch panel 100 of FIG. 3 except that the touch panel 100b further includes second boundary sensing electrodes 140a, fourth wiring lines 180, and fourth pads P4. A repeated description of those similar elements will be omitted. Instead, the following description shall focus on the differences between the touch panel 100b of FIG. 5 and the touch panel 100 of FIG. 3.

Referring to FIG. 5, the second boundary sensing electrodes 140a may be located in a portion of a second sensing area SA2 that is adjacent to a non-sensing area DA. The second boundary sensing electrodes 140a may be formed of substantially the same shape and material as the second sensing electrodes 140. However, the second boundary sensing electrodes 140a may be different from the second sensing electrodes 140 in that the second boundary sensing electrodes 140a are disposed adjacent to the non-sensing area DA. For example, among the electrodes located in the second sensing area SA2, electrodes that are located in a first column R1 and a second column R2 may be defined as the second sensing electrodes 140, and electrodes that are located in a third column R3 closest to the non-sensing area DA may be defined as the second boundary sensing electrodes 140a. Other features of the second boundary sensing electrodes 140a are similar to those of the second sensing electrodes 140, and thus a detailed description of those similar features will be omitted.

In the interest of clarity and for ease of description, among the second boundary sensing electrodes 140a, sensing electrodes that are located in a first row C1, a second row C2, a third row C3 and a fourth row C4 are defined as a first row-second boundary sensing electrode 141a, a second row-second boundary sensing electrode 143a, a third row-second boundary sensing electrode 145a, and a fourth row-second boundary sensing electrode 147a, respectively.

First pads P1 and one or more fourth pads P4 may be located in a portion of an edge area EA that is adjacent to a first sensing area SA1. Second pads P2 and one or more third pads P3 may be located in a portion of the edge area EA that is adjacent to the second sensing area SA2.

A first touch controller IC1 may be connected to the first pads P1 and the fourth pads P4 by a first flexible printed circuit board FPC1, and a second touch controller IC2 may be connected to the second pads P2 and the third pads P3 by a second flexible printed circuit board FPC2.

At least any one of the second boundary sensing electrodes 140a may be connected to a fourth pad P4 by a fourth wiring line 180. For example, among the second boundary sensing electrodes 140a, the first row-second boundary sensing electrode 141a may be connected to a fourth pad P4 by any one (herein referred to as a ‘first row-fourth wiring line’ 181) of the fourth wiring lines 180, and the third row-second boundary sensing electrode 145a may be connected to a fourth pad P4 by the other one (herein referred to as a ‘third row-fourth wiring line’ 183) of the fourth wiring lines 180. In some embodiments, the first row-second boundary sensing electrode 141a and the third row-second boundary sensing electrode 145a that are connected to the fourth wiring lines 180 may not be connected to second wiring lines 150. In addition, the second row-second boundary sensing electrode 143a and the fourth row-second boundary sensing electrode 147a may not be connected to the fourth wiring lines 180, and instead may be connected to second pads P2 by a second row-second wiring line 153 and a fourth row-second wiring line 157. Accordingly, a capacitive change in the first row-second boundary sensing electrode 141a and the third row-second boundary sensing electrode 145a among the second boundary sensing electrodes 140a may be detected as a touch signal by the first touch controller IC1, and a capacitive change in the second row-second boundary sensing electrode 143a and the fourth row-second boundary sensing electrode 147a may be detected as a touch signal by the second touch controller IC2. A final determination on whether a touch event has occurred may be made based on the touch signal detected by each of the first touch controller IC1 and the second touch controller IC2. Accordingly, when a touch event occurs near the non-sensing area DA, a capacitive change in at least any one of first boundary sensing electrodes 120a may be detected by the second touch controller IC2. In addition, a capacitive change in at least any one of the second boundary sensing electrodes 140a may be detected by the first touch controller IC1. Whether a touch event has occurred may be determined based on touch signals detected by the two touch controllers IC1 and IC2. Accordingly, touch sensitivity can be improved in the above embodiments.

The fourth wiring lines 180 may be substantially located in the edge area EA. More specifically, the fourth wiring lines 180 may not be located in the non-sensing area DA, and instead may be located in the second sensing area SA2 and a portion of the edge area EA outside the first sensing area SA1. In some embodiments, at least part of the fourth wiring lines 180 may be located in the first sensing area SA1.

In the example of FIG. 5, both the first row-fourth wiring line 181 and the third row-fourth wiring line 183 among the fourth wiring lines 180 are not located in the non-sensing area DA. However, the above configuration is merely exemplary. In some embodiments, a part of any one of the first row-fourth wiring line 181 and the third row-fourth wiring line 183 may be located in the non-sensing area DA as long as it does not overlap the third wiring lines 170.

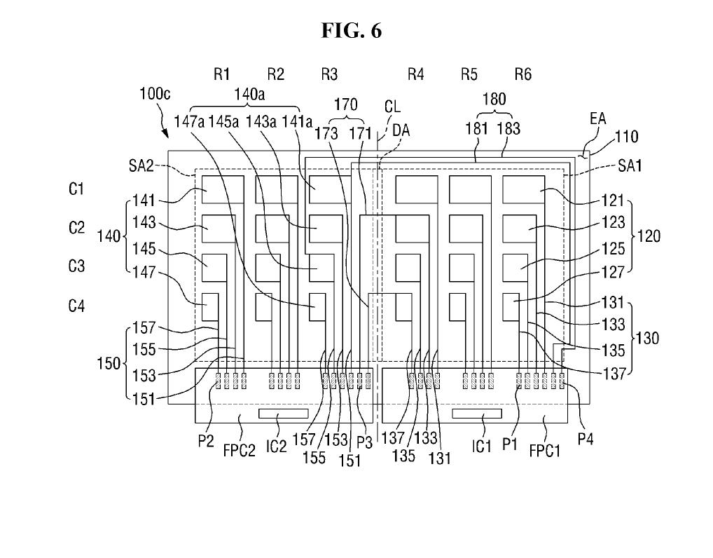

FIG. 6 is a schematic plan view of a touch panel 100c according to another embodiment. The touch panel 100c of FIG. 6 is substantially similar to the touch panel 100b of FIG. 5 except for the connections between first boundary sensing electrodes 120a and first wiring lines 130 and the connections between second boundary sensing electrodes 140a and second wiring lines 150. A repeated description of those similar elements will be omitted. Instead, the following description shall focus on the differences between the touch panel 100c of FIG. 6 and the touch panel 100b of FIG. 5.

Referring to FIG. 6, a second row-first boundary sensing electrode 123a and a fourth row-first boundary sensing electrode 127a that are connected to third wiring lines 170 may also be connected to the first wiring lines 130. Specifically, the second row-first boundary sensing electrode 123a may be electrically connected to a first pad P1 by a second row-first wiring line 133, and the fourth row-first boundary sensing electrode 127a may be connected to a first pad P1 by a fourth row-first wiring line 137. Accordingly, a capacitive change in the second row-first boundary sensing electrode 123a and the fourth row-first boundary sensing electrode 127a among the first boundary sensing electrodes 120a may be detected as a touch signal by both a first touch controller IC1 and a second touch controller IC2, and a capacitive change in a first row-first boundary sensing electrode 121a and a third row-first boundary sensing electrode 125a may be detected as a touch signal by the first touch controller IC1.

In addition, a first row-second boundary sensing electrode 141a and a third row-second boundary sensing electrode 145a that are connected to fourth wiring lines 180 may also be connected to the second wiring lines 150. Specifically, the first row-second boundary sensing electrode 141a may be electrically connected to a second pad P2 by a first row-second wiring line 151, and the third row-second boundary sensing electrode 145a may be electrically connected to a second pad P2 by a third row-second wiring line 155.

Accordingly, a capacitive change in the first row-second boundary sensing electrode 141a and the third row-second boundary sensing electrode 145a among the second boundary sensing electrodes 140a may be detected as a touch signal by both the first touch controller IC1 and the second touch controller IC2, and a capacitive change in a second row-second boundary sensing electrode 143a and a fourth row-second boundary sensing electrode 147a may be detected as a touch signal by the second touch controller IC2.

A final determination on whether a touch event has occurred may be made based on the touch signal detected by each of the first touch controller IC1 and the second touch controller IC2.

In the example of FIG. 6, all of the first boundary sensing electrodes 120a are connected to the first wiring lines 130, and all of the second boundary sensing electrodes 140a are connected to the second wiring lines 150. However, the inventive concept is not limited thereto. For example, in some embodiments, some of the first boundary sensing electrodes 120a may not be connected to the first wiring lines 130, and all of the second boundary sensing electrodes 140a may be connected to the second wiring lines 150. In some alternative embodiments, all of the first boundary sensing electrodes 120a may be connected to the first wiring lines 130, and some of the second boundary sensing electrodes 140a may not be connected to the second wiring lines 150.

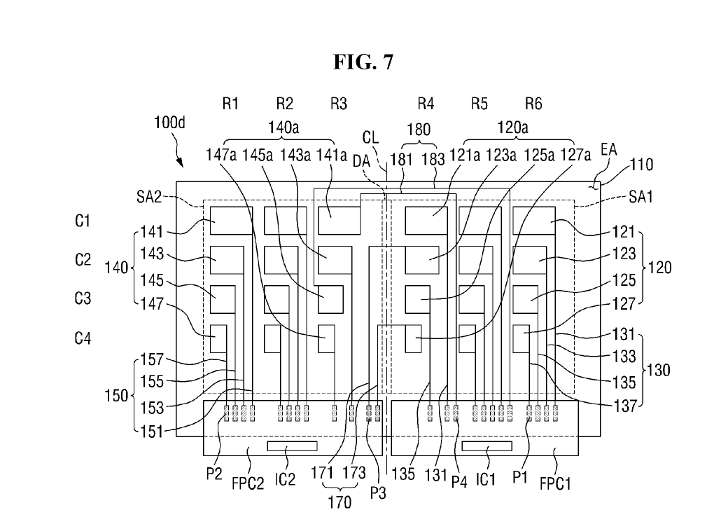

FIG. 7 is a schematic plan view of a touch panel 100d according to another embodiment. The touch panel 100d of FIG. 7 is substantially similar to the touch panel 100b of FIG. 5 except for the positions of fourth wiring lines 180. A repeated description of those similar elements will be omitted. Instead, the following description shall focus on the differences between the touch panel 100d of FIG. 7 and the touch panel 100b of FIG. 5.

Referring to FIG. 7, part of the fourth wiring lines 180 may be located in a first sensing area SA1. More specifically, the fourth wiring lines 180 may be located in a second sensing area SA2 and in the first sensing area SA1 via an edge area EA. In particular, respective portions of the fourth wiring lines 180 that are located in the first sensing area SA1 may extend into a space between sensing electrodes 120 and 120a located in the first sensing area SA1, such that the fourth wiring lines 180 are connected to fourth pads P4. For example, the fourth wiring lines 180 may extend into a space between first boundary sensing electrodes 120a located in a fourth column R4 and first sensing electrodes 120 located in a fifth column R5, or into a space between the first sensing electrodes 120 located in the fifth column R5 and first sensing electrodes 120 located in a sixth column R6, such that the fourth wiring lines 180 are connected to the fourth pads P4.

In the example of FIG. 7, a first row-fourth wiring line 181 and a third row-fourth wiring line 183 among the fourth wiring lines 180 are all located in the first sensing area SA1. However, the above configuration is merely exemplary. In some embodiments, any one of the first row-fourth wiring line 181 and the third row-fourth wiring line 183 may be substantially located in the edge area EA, as previously illustrated in FIG. 5.

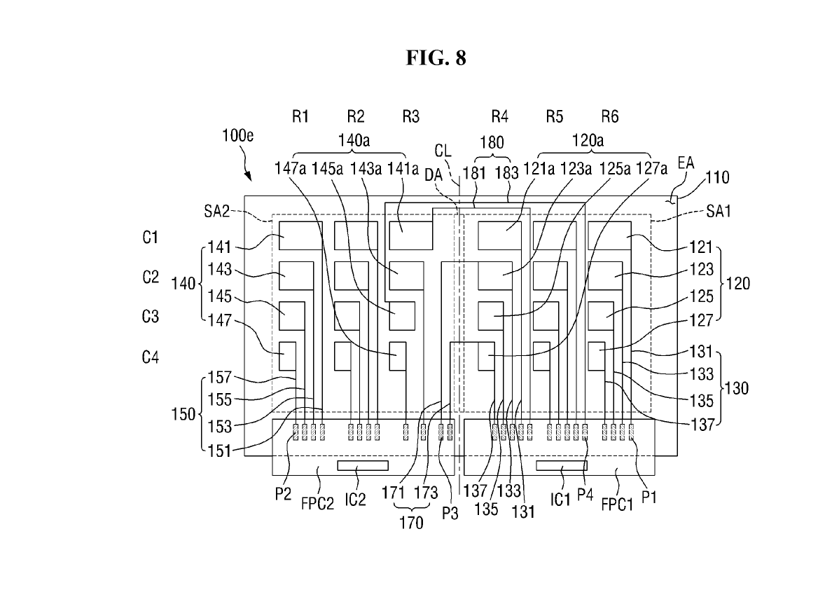

FIG. 8 is a schematic plan view of a touch panel 100e according to another embodiment. The touch panel 100e of FIG. 8 is substantially similar to the touch panel 100d of FIG. 7 except for the connections between first boundary sensing electrodes 120a and first wiring lines 130, and the connections between second boundary sensing electrodes 140a and second wiring lines 150.

Referring to FIG. 8, a second row-first boundary sensing electrode 123a and a fourth row-first boundary sensing electrode 127a that are connected to third wiring lines 170 may also be connected to the first wiring lines 130. Accordingly, a capacitive change in the second row-first boundary sensing electrode 123a and the fourth row-first boundary sensing electrode 127a among the first boundary sensing electrodes 120a may be detected as a touch signal by both a first touch controller IC1 and a second touch controller IC2, and a capacitive change in a first row-first boundary sensing electrode 121a and a third row-first boundary sensing electrode 125a may be detected as a touch signal by the first touch controller IC1.

In addition, a first row-second boundary sensing electrode 141a and a third row-second boundary sensing electrode 145a that are connected to fourth wiring lines 180 may also be connected to the second wiring lines 150. Accordingly, a capacitive change in the first row-second boundary sensing electrode 141a and the third row-second boundary sensing electrode 145a among the second boundary sensing electrodes 140a may be detected as a touch signal by both the first touch controller IC1 and the second touch controller IC2, and a capacitive change in a second row-second boundary sensing electrode 143a and a fourth row-second boundary sensing electrode 147a may be detected as a touch signal by the second touch controller IC2.

A final determination on whether a touch event has occurred may be made based on the touch signal detected by each of the first touch controller IC1 and the second touch controller IC2.

In the example of FIG. 8, all of the first boundary sensing electrodes 120a are connected to the first wiring lines 130, and all of the second boundary sensing electrodes 140a are connected to the second wiring lines 150, similar to the embodiment illustrated in FIG. 6.

In the foregoing description, different embodiments of a touch panel having improved touch detection sensitivity and a display device including the touch panel have been disclosed.

While the inventive concept has been illustrated and described with reference to certain exemplary embodiments, it will be understood by one of ordinary skill in the art that various changes may be made to the embodiments without departing from the spirit and scope of the inventive concept. Therefore, the embodiments should be construed in a descriptive sense and not in a limiting manner.

What is claimed is:

1. A touch panel comprising:
a substrate comprising a first sensing area, a second sensing area, and a non-sensing area located between the first sensing area and the second sensing area;
a plurality of first sensing electrodes located on the first sensing area of the substrate;
a plurality of second sensing electrodes located on the second sensing area of the substrate;
a first boundary sensing electrode located at a boundary between the first sensing area and the non-sensing area of the substrate;
a plurality of first wiring lines partially located on the first sensing area of the substrate and connected to the first sensing electrodes;
a plurality of second wiring lines partially located on the second sensing area of the substrate and connected to the second sensing electrodes;
a first touch controller electrically connected to the first sensing electrodes by the first wiring lines;
a second touch controller electrically connected to the second sensing electrodes by the second wiring lines; and
a third wiring line electrically connected to the first boundary sensing electrode and the second touch controller.

2. The touch panel of claim 1, wherein at least part of the third wiring line is located on the non-sensing area of the substrate.

3. The touch panel of claim 1, wherein the substrate further comprises an edge area located around the first sensing area and the second sensing area, and wherein at least part of the third wiring line is located on the edge area of the substrate.

4. The touch panel of claim 1, wherein the first boundary sensing electrode is electrically connected to the first touch controller by any one of the first wiring lines.

5. The touch panel of claim 1, wherein the first boundary sensing electrode is not connected to any of the first wiring lines.

6. The touch panel of claim 1, further comprising:
a second boundary sensing electrode located at a boundary between the second sensing area and the non-sensing area of the substrate; and
a fourth wiring line electrically connected to the second boundary sensing electrode and the first touch controller.

7. The touch panel of claim 6, wherein at least part of the fourth wiring line is located on the first sensing area of the substrate.

8. The touch panel of claim 6, wherein the substrate further comprises an edge area located around the first sensing area and the second sensing area, and wherein at least part of the fourth wiring line is located on the edge area of the substrate.

9. The touch panel of claim 6, wherein the second boundary sensing electrode is electrically connected to the second touch controller by any one of the second wiring lines.

10. The touch panel of claim 6, wherein the second boundary sensing electrode is not connected to any of the second wiring lines.

11. The touch panel of claim 1, wherein the first sensing electrodes and the second sensing electrodes are located on a same layer.

12. The touch panel of claim 11, wherein the first sensing electrodes and the second sensing electrodes are made of a same material.

13. The touch panel of claim 11, wherein the first wiring lines, the second wiring lines, and the third wiring line are located on the same layer as the first sensing electrodes and the second sensing electrodes.

14. A display device comprising:
a touch panel; and
a display panel disposed on a side of the touch panel,
wherein the touch panel comprises:
a substrate comprising a first sensing area, a second sensing area, and a non-sensing area located between the first sensing area and the second sensing area;
a plurality of first sensing electrodes located on the first sensing area of the substrate;
a plurality of second sensing electrodes located on the second sensing area of the substrate;
a first boundary sensing electrode located at a boundary between the first sensing area and the non-sensing area of the substrate;
a plurality of first wiring lines partially located on the first sensing area of the substrate and connected to the first sensing electrodes;
a plurality of second wiring lines partially located on the second sensing area of the substrate and connected to the second sensing electrodes;
a first touch controller electrically connected to the first sensing electrodes by the first wiring lines;
a second touch controller electrically connected to the second sensing electrodes by the second wiring lines; and
a third wiring line electrically connected to the first boundary sensing electrode and the second touch controller.

15. The display device of claim 14, wherein the display panel comprises an organic light-emitting device or a liquid crystal device.
